(19) United States
(12) Patent Application Publication
(10) Pub. No.: US 2019/0078354 A1
(43) Pub. Date: Mar. 14, 2019

(54) CYLINDRICAL LATCH EXIT DEVICE

(71) Applicant: Hampton Products International Corporation, Foothill Ranch, CA (US)

(72) Inventors: Jason L. Quinn, Spooner, WI (US); Lucas J. Stanton, Stone Lake, WI (US)

(73) Assignee: Hampton Products International Corporation, Foothill Ranch, CA (US)

(21) Appl. No.: 16/129,709

(22) Filed: Sep. 12, 2018

Related U.S. Application Data
(60) Provisional application No. 62/557,352, filed on Sep. 12, 2017.

(51) Int. Cl. E05B 65/10; E05B 17/20; E05C 1/08

(52) U.S. Cl. CPC E05B 65/1073; E05B 17/2034; E05Y 2900/132; E05B 65/1053; E05B 65/1093; E05C 1/08

(57) ABSTRACT

A push bar door exit device includes a latch actuation assembly configured to be installed in a door and including a linearly-movable latch retractor; a door latch operatively coupled to the latch retractor so as to be moved from a latched position to an unlatched position by the linear movement of the latch retractor; and a push bar mechanism configured for being mounted on the door and including a linearly-movable push bar operatively coupled to the latch actuation assembly so as to translate a linear motion of the push bar into the linear movement of the latch retractor.

### CROSS REFERENCE TO RELATED APPLICATION

This application claims the benefit, under 35 U.S.C. § 119(e), of U.S. Provisional Application No. 62/557,352, filed Sep. 12, 2017, the disclosure of which is incorporated herein by reference in its entirety.

### FEDERALLY SPONSORED RESEARCH OR DEVELOPMENT

Not applicable.

### FIELD OF THE ART

The present disclosure pertains to door latches, exit door latching, and related methods, and more particularly to a cylindrical latching device.

### BACKGROUND

Doors can have different types of mechanisms to activate a latch. In buildings, doors can often have cylindrical latches, as commonly seen with doorknobs or rotating door handles. In other instances, doors can have exit devices that allow for linear actuation. Exit devices are typically installed on the inside of a door and operated by depression of a spring-loaded push bar into a push bar housing to actuate a latch. In this way, a user can open the door by pushing in the direction of the opening of the door.

### SUMMARY

Generally, exit devices are made to either install using a rim mounted strike and latch bolt, or a single or multi-point vertical latch design, on a surface of the door. In addition to the surface mounted hardware, if the door has been prepared for a cylindrical latch, some type of patch or plug must be used to retain the fire rating of the door before installing the exit device.

The present disclosure relates, in an aspect, to an exit device which can utilize the existing opening in the door that has been prepared for a cylindrical latch. In embodiments, the door can be provided with a doorknob or rotating door handle on one side of the door and a push bar on the other side of the door. The use of the cylindrically mounted hardware can eliminate the need for a surface mounted strike and provide for a visually appealing look.

The present disclosure relates, in an aspect, to a cylindrical latch exit device including a first side having a rotational handle, a second side having a push bar, and a cylindrical latch assembly contained within a door and having a retractor, wherein the push bar is coupled to a pull pivot configured to linearly actuate the retractor.

Broadly, this disclosure relates to an exit device wherein a push bar of the exit device on an interior side of the door is used to actuate a cylindrical latch assembly. The cylindrical latch assembly can allow for conversion of a rotational movement of a handle on an exterior side of the door into the linear motion of a retractor and a latch coupled to the retractor. The retractor can also be actuated in a linear manner by the actuation of the push bar. In this way, the exit device can utilize the existing opening in the door that has been prepared for a cylindrical latch assembly. This can eliminate the need for a patch or plug in the door. Additionally, the actuation of the cylindrical latch assembly can eliminate the surface mounted strike of the exit device.

In accordance with aspects of the disclosure, a push-bar door exit assembly for actuating a cylindrical latch mechanism that is operatively coupled to a door latch comprises a carrier having a mounting surface configured to be mounted on a surface of a door; a push bar disposed in the carrier so as to be linearly movable in a first direction generally orthogonal to the mounting surface of the carrier; and a latch actuator operably coupling the rotatable cylindrical latch mechanism to the push bar so as to cause the cylindrical latch mechanism to move the door latch linearly in a second direction parallel to the mounting surface of the carrier in response to the linear movement of the push bar in the first direction.

### BRIEF DESCRIPTION OF THE DRAWINGS

FIG. 1 shows a top plan view with a partial cutaway of the cylindrical latch exit device in accordance with an aspect of this disclosure, as installed in a door.

FIG. 2 shows a perspective view of the cylindrical latch exit device from the exterior handle set side.

FIG. 3 shows a perspective view of the cylindrical latch exit device from the push bar side.

FIGS. 4 and 5 show exploded perspective views of the cylindrical latch exit device.

FIG. 6 shows a close-up view of the embodiment shown in FIG. 5 in a non-actuated state.

FIG. 7 shows a close-up view of the embodiment shown in FIG. 5 in an actuated state.

FIG. 8 shows a plan top cross sectional view of the embodiment shown in FIG. 6.

FIG. 9 shows a cross sectional view of the embodiment shown in FIG. 7 in an actuated state.

FIG. 10 shows a cross sectional view of the embodiment shown in FIG. 6 in a non-actuated state, as installed in a door.

FIG. 11A shows a top plan view with partial cutaway showing a door, an exterior handle set, and a push bar assembly connected to the head piece.

FIG. 11B shows a partial perspective view with partial cutaway showing a door, the exterior handle set, and the push bar assembly connected to the head piece.

FIG. 12A shows a partial perspective view with partial cutaway showing a door, an exterior handle set, and a push bar assembly connected to the head piece.

FIG. 12B shows a partial perspective view with partial cutaway showing the head piece, the actuator pin, and the pull linkage of the head piece.

FIG. 13A shows a partial perspective view with partial cutaway showing a door, an exterior handle set, and a push bar assembly connected to the head piece.

FIG. 13B shows a partial perspective view with partial cutaway showing the head piece, the actuator pin, and the pull linkage of the head piece.

### DETAILED DESCRIPTION

The detailed description set forth below in connection with the appended drawings is intended as a description of the presently preferred embodiments of cylindrical latch exit devices provided in accordance with aspects of the present components, assemblies, and method, and it is not intended to represent the only forms in which the present components, assemblies, and method may be constructed or utilized. The description sets forth the features and the steps for constructing and using the embodiments of the present components, assemblies, and method in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

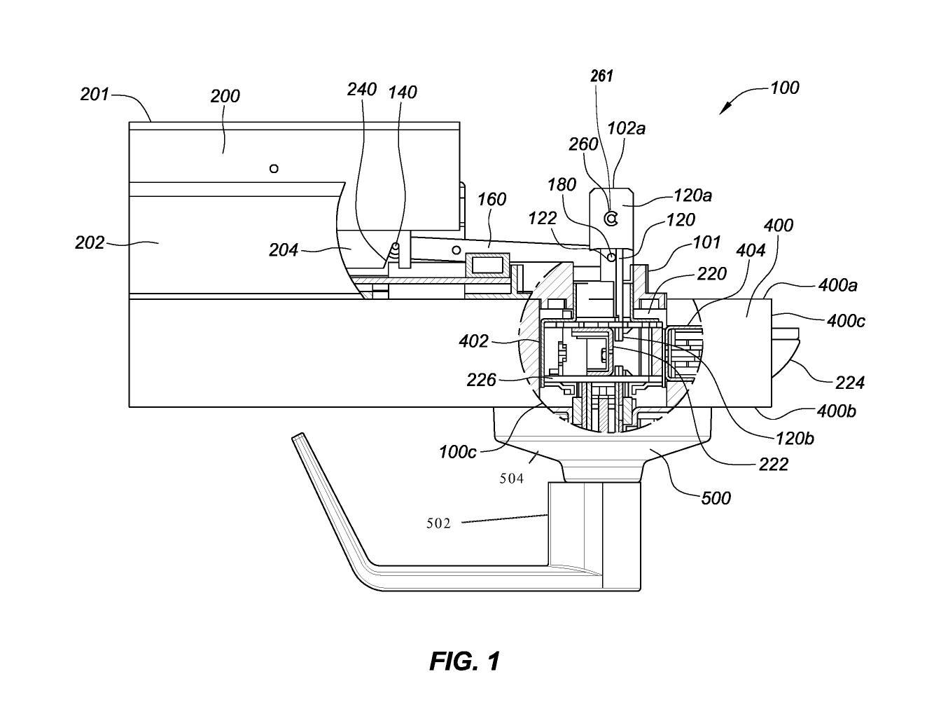

FIGS. 1-10 illustrate an exemplary embodiment of a cylindrical latch exit device 100.

FIG. 1 illustrates a top plan view with a partial cutaway 100c of the cylindrical latch exit device 100. The cylindrical latch exit device 100 is configured to be installed in a door 400. The cylindrical latch exit device 100 may comprise a push bar assembly 200 including a push bar 201, and a latch actuation assembly 220 coupled to the push bar assembly 200.

The door 400 can have a first opening 402 extending through the door from a first surface 400a to an opposed second surface 400b. The first opening 402 is sized and shaped to accommodate the latch actuation assembly 220. The door 400 can have a second opening 404 extending from the first opening 402 to a side surface 400c. The second opening 404 is sized and shaped to accommodate a latch 224 actuated by the latch actuation assembly 220.

The latch actuation assembly 220 may be generally configured to function as a cylindrical latch actuation assembly, as would be understood in the art. The latch actuation assembly 220 can include a retractor or transmission plate 222. The retractor 222 can be coupled to the latch 224, such that linear movement of the retractor can result in the linear movement of the latch 224 between an extended (latched) position and a retracted (unlatched) position. The retractor 222 can be housed in a cage 226 of the latch assembly 220.

On the second surface 400b, there can be an exterior handle set 500 including a rotating handle 502 and (optionally) a rosette 504 as would be understood in the art. The exterior handle set 500 can be coupled to the latch actuation assembly 220 such that rotation of the handle 502 results in actuation of the retractor 222, and thereby actuation/retraction of the latch 224. The translation by rotation can be achieved by conventional options, including, for example, a cam pushing against an inside surface of the retractor 222 as the handle 502 is rotated.

The push bar assembly 200 can have a carrier 202 mounted to the first door surface 400a. The push bar 201 can be coupled to the carrier 202, and an actuator 204 can be coupled to the push bar 201. The actuator 204 can be configured to move in a direction parallel or nearly parallel to the first door surface 400a in translation of movement of the push bar 201 in a direction perpendicular or at an angle approximately perpendicular to the first door surface 400a.

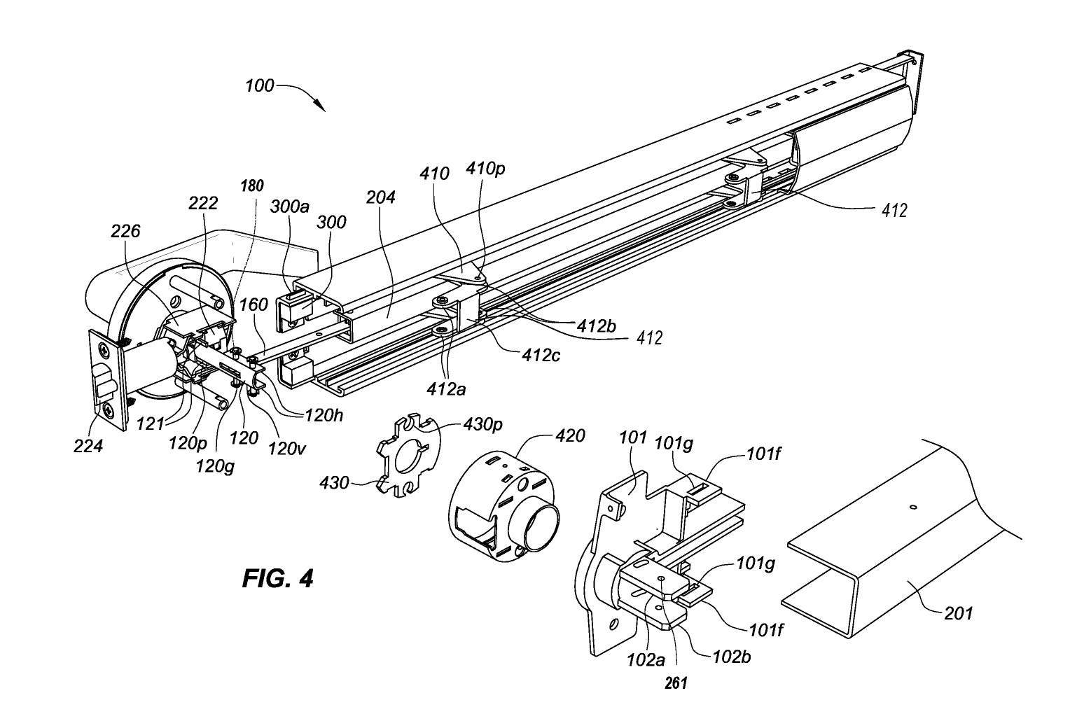

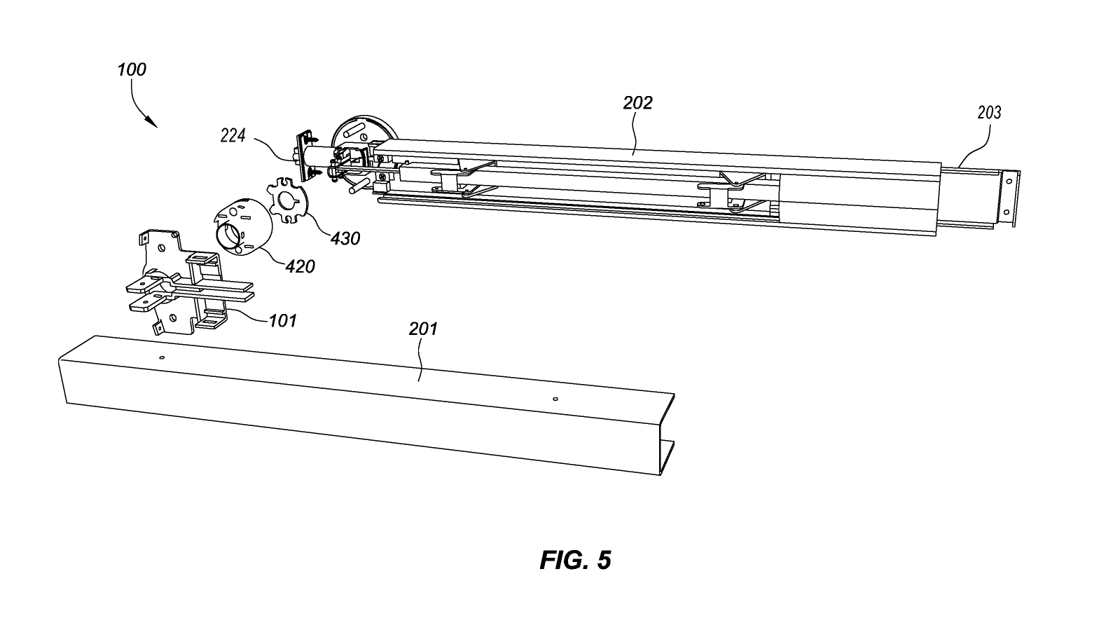

The actuator 204 can have a slot 240 sized and shaped for coupling with an actuator pin 140 that couples the actuator 204 with a pull linkage 160. The actuator 204 can operatively couple the push bar assembly 200 to the cylindrical latch actuation assembly 220 so as to translate a motion of the push bar 201 in one direction into a linear movement of the retractor 222 that moves the latch 224 from the latched position to the unlatched position. The pull linkage 160 can be coupled to a pull pivot 120 at an intermediary hole 122 through an intermediary pin 180 (see FIG. 4). The pull pivot 120 can be rotatably fixed near a first end 120a to mounting tabs 102a, 102b (see FIG. 5) by a fixing pin 260 at a fixing hole 261. The mounting tabs 102a, 102b can be an integrally formed part of a head piece 101. A second end 120b of the pull pivot 120 can be coupled with the retractor 222. In this way, the pull pivot 120 can rotate around the fixing pin 260. When the actuator 204 moves parallel to the first door surface 400a, the pull linkage is similarly moved in a substantially similar direction. The pinned ends of the pull linkage 160 allow for movement without binding as the pull pivot 120 rotates. As the first end 120a of the pull pivot 120 is rotatably fixed, the movement of the pull linkage 160 results in movement at the second end 120b of the pull pivot 120, thereby linearly actuating the retractor 222. The retractor 222 can have its movement constrained by the cage 226, which can house the retractor 222. The cage 226 can restrict movement of the retractor 222 to a linear direction. Accordingly, when the push bar 201 is pressed, the motion of the push bar 201 translates into a movement of the actuator 204 away from the side surface 400c of the door 400. The movement of the actuator 204, in turn, moves the pull linkage 160 and in turn pulls the pull pivot 120 so as to urge the retractor 222 in a direction away from the side surface 400c of the door 400. The movement of the retractor 222 thereby moves the latch 224.

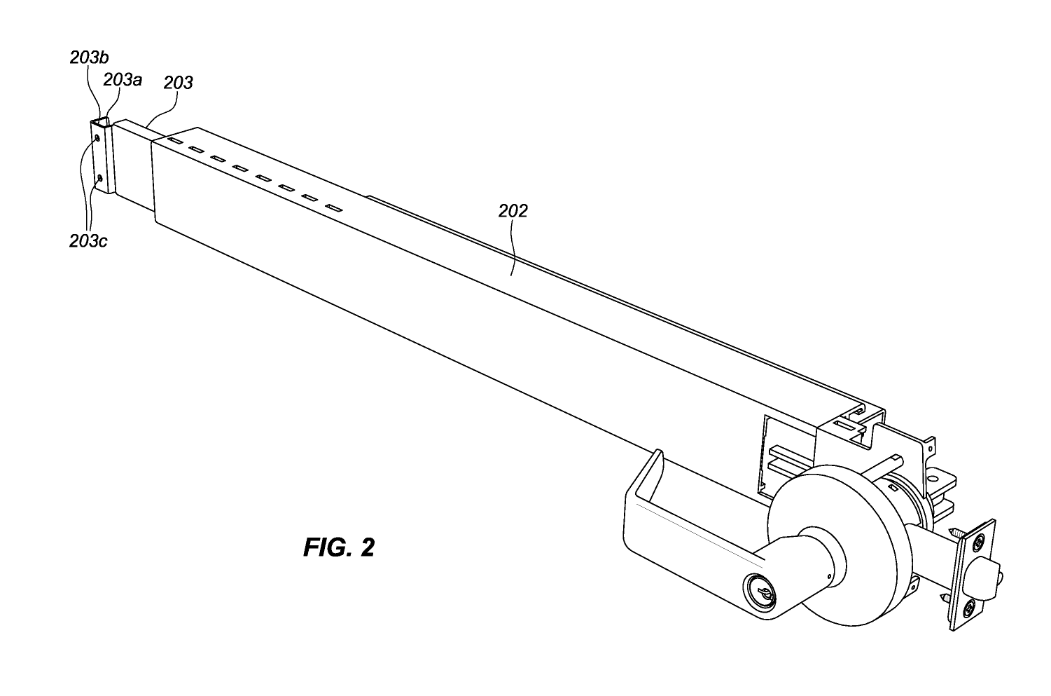

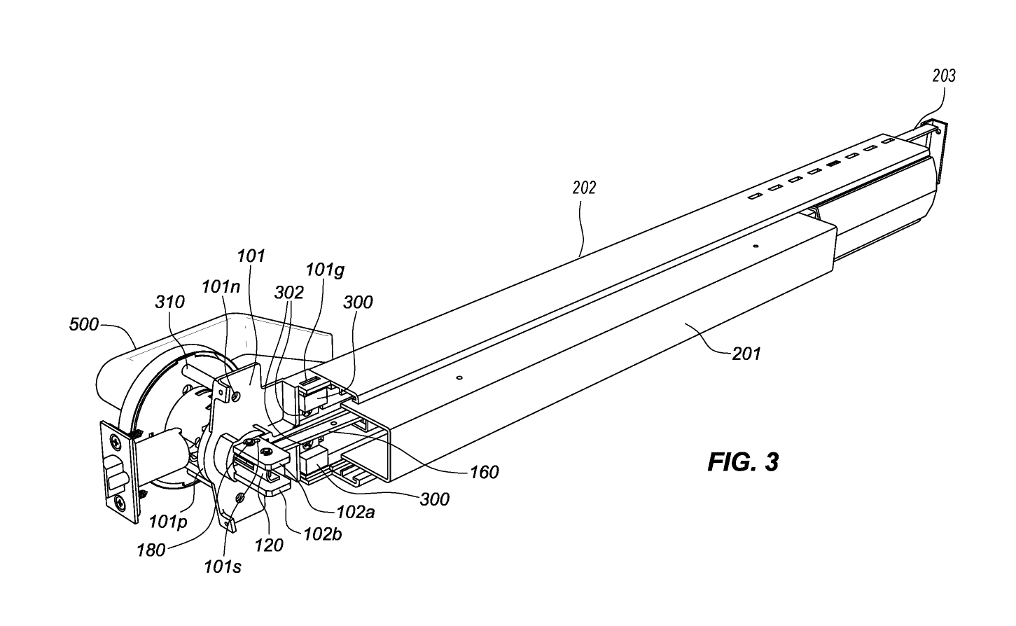

FIGS. 2 and 3 are perspective views of the cylindrical latch exit device 100 in an assembled state. FIG. 2 shows the cylindrical latch exit device 100 from the exterior handle set 500 side. The carrier 202 can be coupled with a mounting bracket 203 near a distal end of the carrier 202. The mounting bracket 203, extending distally from the carrier 202, can be mounted on an interior of the carrier 202. The mounting bracket 203 can have bends to form a first surface 203a, perpendicular to the first surface 400a of the door 400, and a second surface 203b, perpendicular to the first surface 203a of the mounting bracket 203. These bends can allow for the second surface 203b to be flush with the first surface 400a of the door 400 while the carrier 202 is also flush with the first surface 400a of the door.

FIG. 3 shows the cylindrical latch exit device 100 from the push bar assembly 200 side. The head piece 101 can have a pair of mounting tabs 102a, 102b on upper and lower sides, respectively, of the pull pivot 120. The head piece 101 can have a projection 101p on a side facing the door 400, wherein the projection 101p can extend into the first opening 402 of the door 400.

The head piece 101 can have an intermediary slot 101s on each of the mounting tabs 102a, 102b for receiving the intermediary pin 180 coupling the pull pivot 120 to the pull linkage 160. The intermediary slot 101s can define the movement path of the pull linkage 160 acting on the pull pivot 120.

The exterior handle set 500 can include screw posts 310 for fixing the orientation of the exterior handle set 500 relative to the latch assembly. The head piece 101 can have through holes 101n corresponding to the screw posts 310. Fasteners can be used to fix the head piece 101 relative to the screw posts 310.

The mounting bracket 203 can extend along the length of the carrier 202. The mounting bracket 203 can extend beyond a proximal end of the carrier 202 and have mounting blocks 300 attached to it by screws 302. The head piece 101 can have grooves 101g that couple to the mounting blocks 300, as shown in FIG. 4.

FIGS. 4 and 5 illustrate exploded perspective views of the cylindrical latch exit device 100. In the cylindrical latch exit device 100, the first end of the pull pivot 120 can have a generally C shaped profile. The C shape can be formed from a vertical sidewall 120v and two horizontal sidewalls 120h. The C shaped profile can be sized and shaped to fit between the two mounting tabs 102a, 102b of the head piece 101. At the second end 120b of the pull pivot 120 can be a paddle 120p sized and shaped to actuate the retractor 222 for actuating the latch 224. The paddle 120p can include two leaves 121 extending from the vertical sidewall 120v. Also, the vertical sidewall 120v can have a groove or slot 120g sized and shaped to allow movement of the pull linkage 160 and prevent binding. With the actuation of the retractor, the retractor can move relative to the surrounding cage 226.

The actuator 204 can be activated by at least one presser 412. The illustrated embodiment shows two pressers 412, spaced apart along the length of the actuator 204. The presser(s) 412 can translate the movement of the push bar 201 by a user pushing it, into movement perpendicular to the direction of the pushing. The presser(s) 412 can have a chair shape defined by two L shaped pieces and a cross member. The L shaped pieces can be defined by a first leg 412a and a second leg 412b at an oblique angle relative to the first leg 412a. Two L shaped pieces, each having the first leg and the second leg, can be connected at by a cross member 412c at an intermediary position of the first legs 412a. A distal portion of the second leg 412b can be connected to the actuator 204. Each presser 412 can be connected to a presser bracket 410 at a pivot location 410p between the first leg 412a and the second leg 412b. The presser bracket(s) 410 can be fixed to at least one of the mounting bracket 203 and the carrier 202.

With this configuration, when the push bar 201 is pushed by a user, the push bar 201 can pivotally engage with or contact at least one of the first leg 412a and the cross member 412c. From the pushing of the push bar 201 on the first leg 412a and the cross member 412c, each presser 412 is biased to rotate around the pivot location 410p. Due to this rotation, the second leg 412b moves laterally relative to the push bar 201. As the actuator 204 is coupled to the second leg 412b, the actuator 204 is thereby also moved laterally relative to the push bar. This motion can allow for the actuator 204 to provide the necessary motion to actuate the pull pivot 120.

The head piece can have a flange 101f with a groove 101g. The flange and the groove can be provided at upper and lower locations. The groove 101g can correspond to a projection 300a from the mounting block 300. In this way, the head piece can be a snap fit with the mounting block 300. By having upper and lower locations, the entire cylindrical latch exit device 100 can be held as one piece.

Additionally, the cylindrical latch exit device 100 can include a first opening bracket 420 and a cover plate 430. The first opening bracket 420 can be generally cylindrical and open at each end, and it is sized to fit the first opening of a door. The first opening bracket 420 can also have an opening on the cylindrical side surface to accommodate fitment of the retractor 222 and/or latch 224 through the first opening bracket 420 for assembly. The cover plate 430 can have protrusions for retention relative to the other components of the cylindrical latch exit device 100.

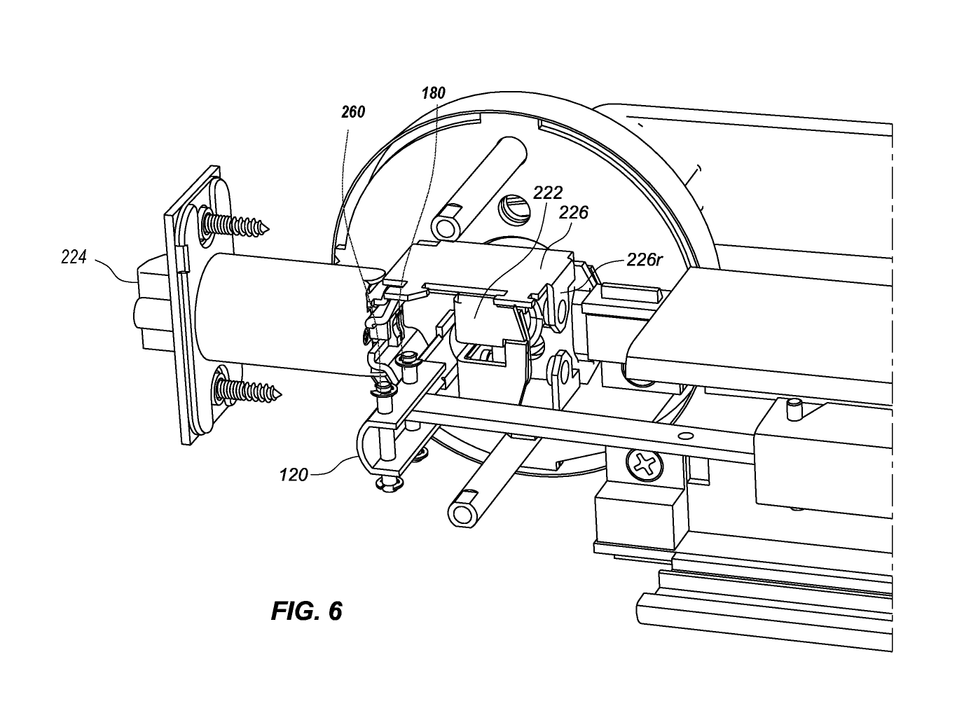

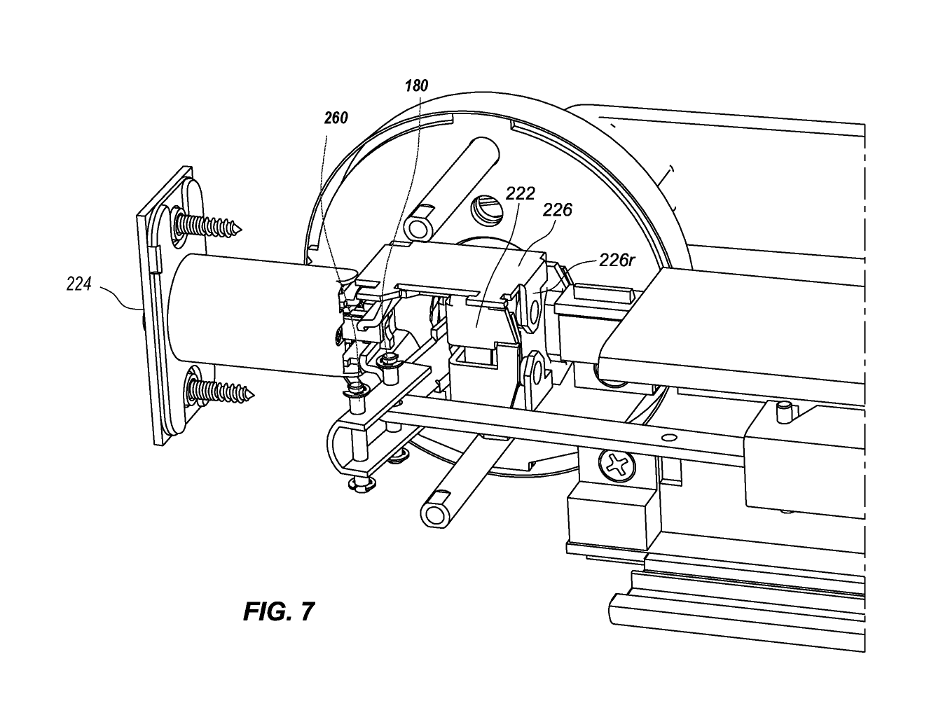

FIGS. 6 and 7 are close up views of the embodiment shown in FIG. 5. FIG. 6 shows a non-actuated state, while FIG. 7 shows an actuated state. In the non-actuated state, the pull pivot 120 is not actuating the retractor 222. In this state, the paddle 120p of the pull pivot 120 can either contact or not contact the retractor 222. In this state, the retractor 222 is in a first position relative to the cage 226. In the actuated state (FIG. 7), the pull pivot 120 is actuating the retractor 222 to actuate/retract the latch 224. In this state, the paddle 120p of the pull pivot can be in contact with the retractor 222, and is biasing the retractor 222 towards the push bar 201. In this state, the retractor 222 is in a second position relative to the cage 226. In comparison to the first state shown in FIG. 6, the retractor 222 is closer to the push bar 201 in the second state than in the first state. Also, the retractor 222 is closer to a rear portion 226r of the cage 226 in the second state than in the first state.

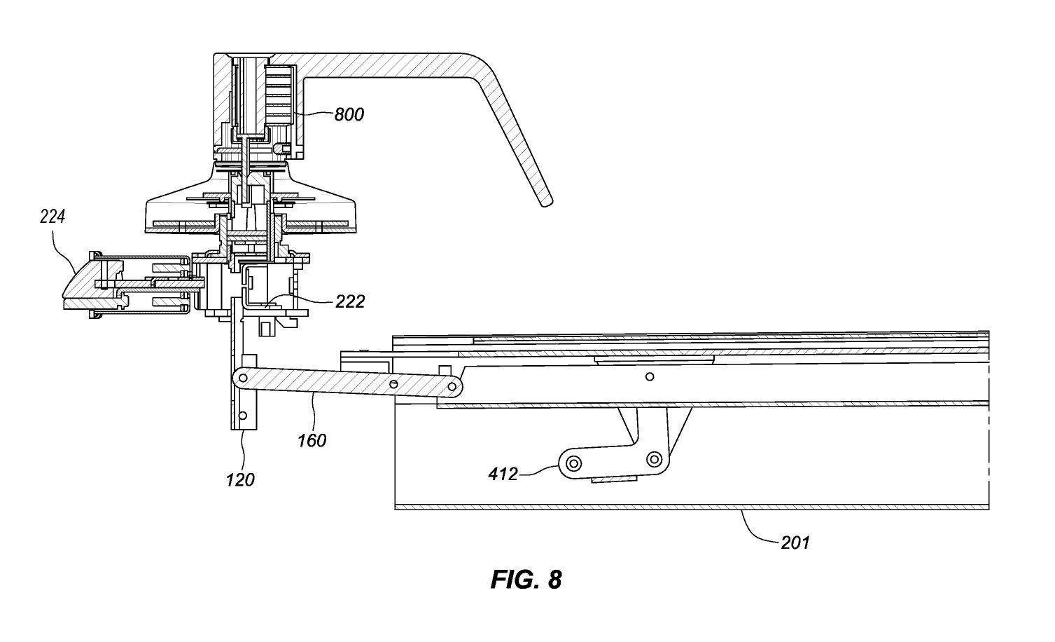

FIG. 8 is a plan top cross sectional view of the embodiment shown in FIG. 7. FIG. 8 shows an embodiment in an actuated state wherein the actuation is by the push bar 201 and thereby the pull pivot 120 rather than the external handle set 500. As shown, as the pull pivot 120 in located on one half of the retractor 222 and does not interfere with the operation of the cylindrical rotation side of the external handle set 500.

As the normal function of the external handle set 500 is not affected by the pull pivot, since the external handle set 500 can fully interface with at least half of the retractor 222, conventional components such as a locking mechanism 800 can be included.

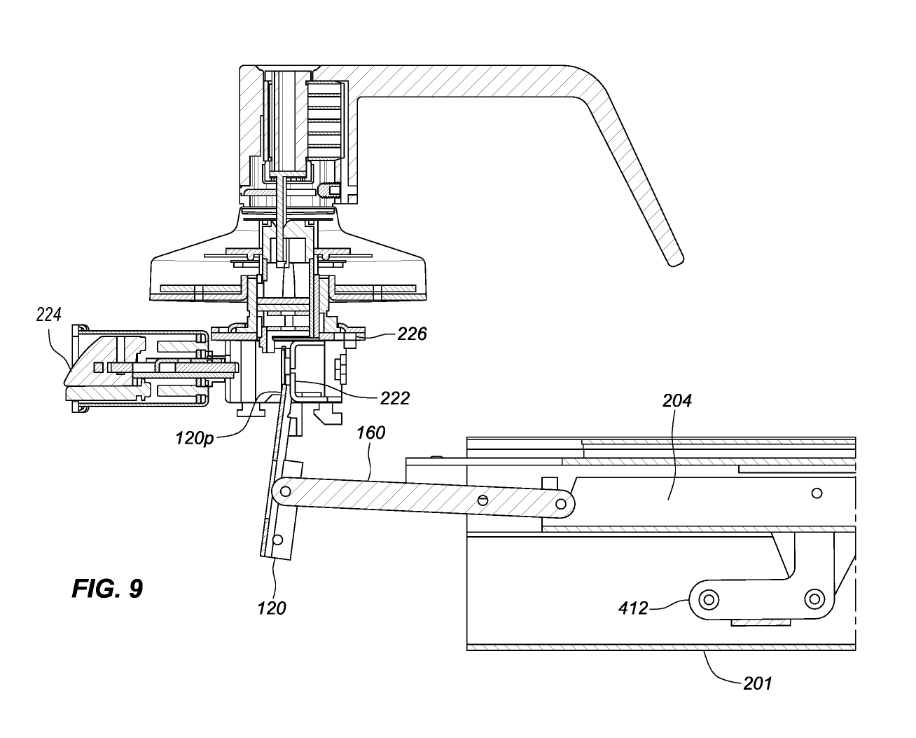

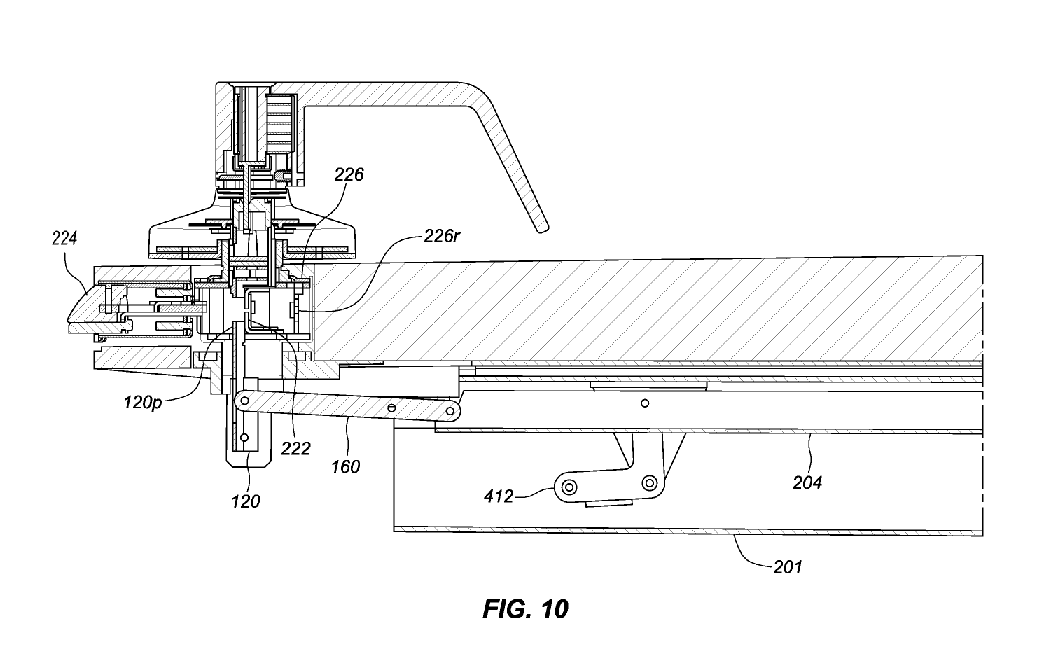

FIGS. 9 and 10 are cross sectional views of the embodiment shown in FIGS. 6 and 7. FIG. 9 illustrates an actuated stated and FIG. 10 illustrates a non-actuated state.

FIG. 9 illustrates the actuated state where the pull pivot 120 is actuating the retractor 222. In this state, the presser 412 is rotated, thereby actuating the actuator 204 and in turn the pull linkage 160 and the pull pivot 120. In this state, the paddle 120p of the pull pivot 120 can be in contact with the retractor 222, and is biasing the retractor 222 towards the push bar 201. In this state, the retractor 222 is in the second position relative to the cage 226.

FIG. 10 illustrates the non-actuated state where the pull pivot 120 is not actuating the retractor 222. In this state, the paddle 120p of the pull pivot can either contact or not contact the retractor 222. In this state, the retractor 222 is in the first position relative to the cage 226. In comparison to the actuated state shown in FIG. 9, the retractor 222 is farther from the push bar 201, and the retractor 222 is farther from a rear portion 226r of the cage 226.

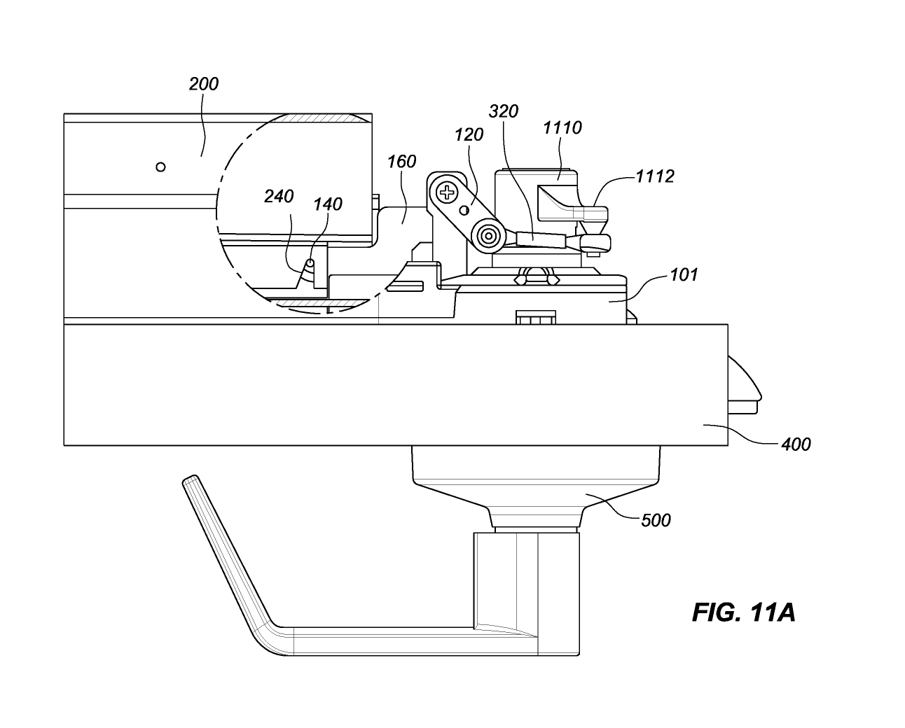

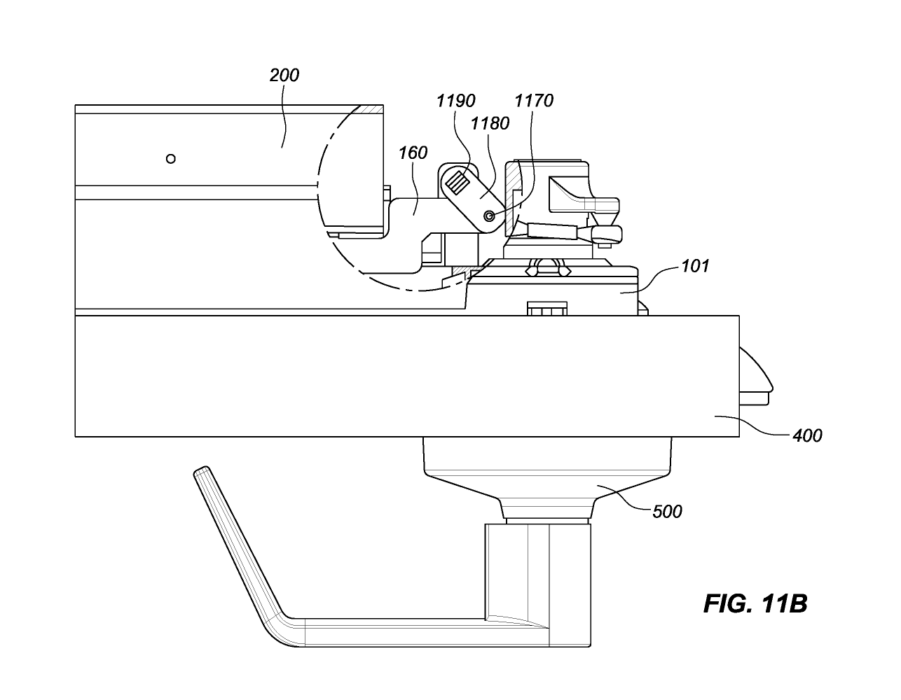

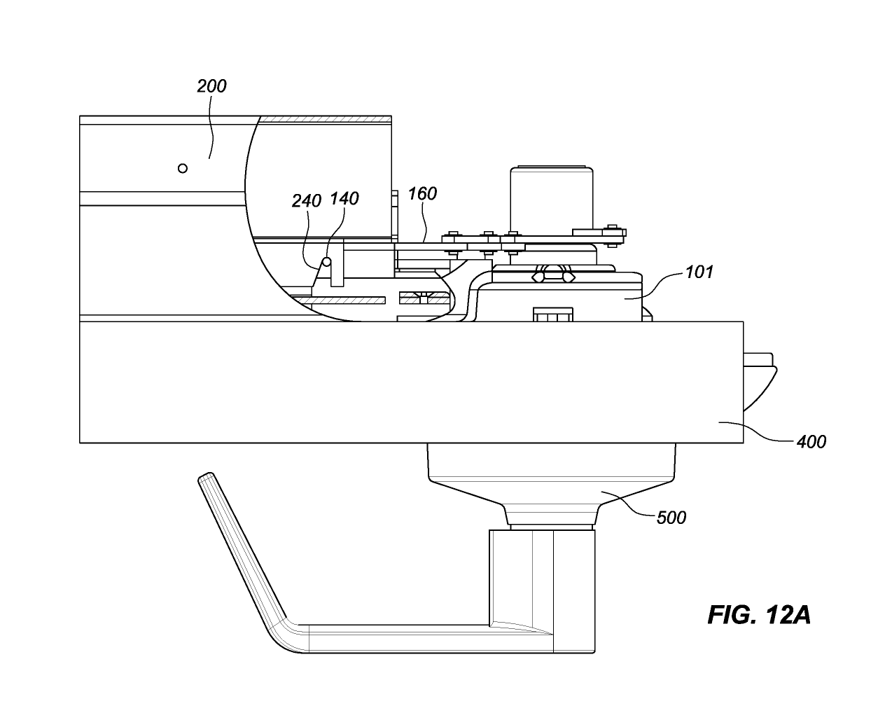

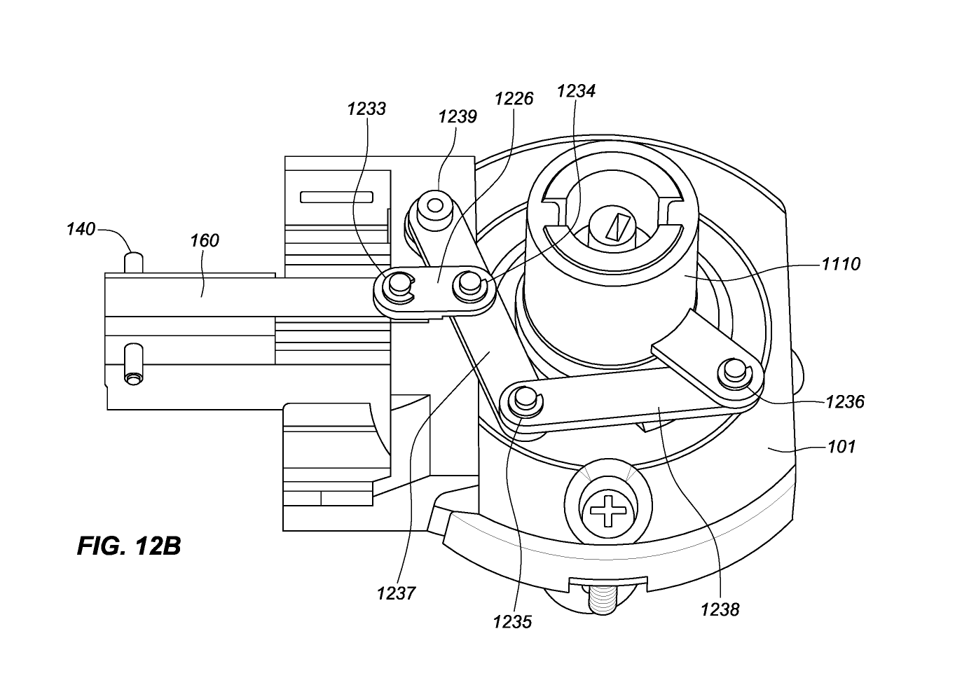

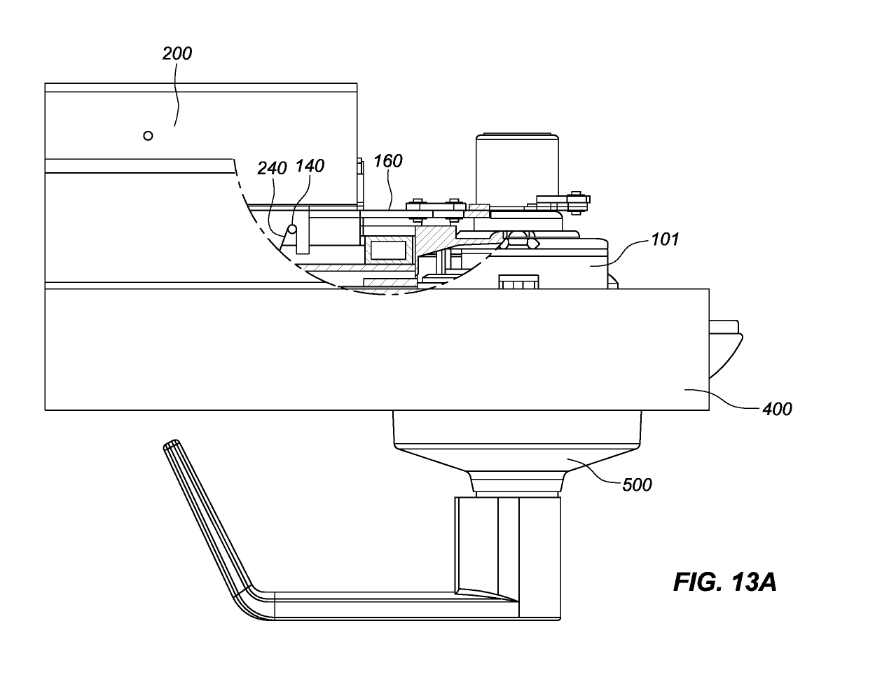

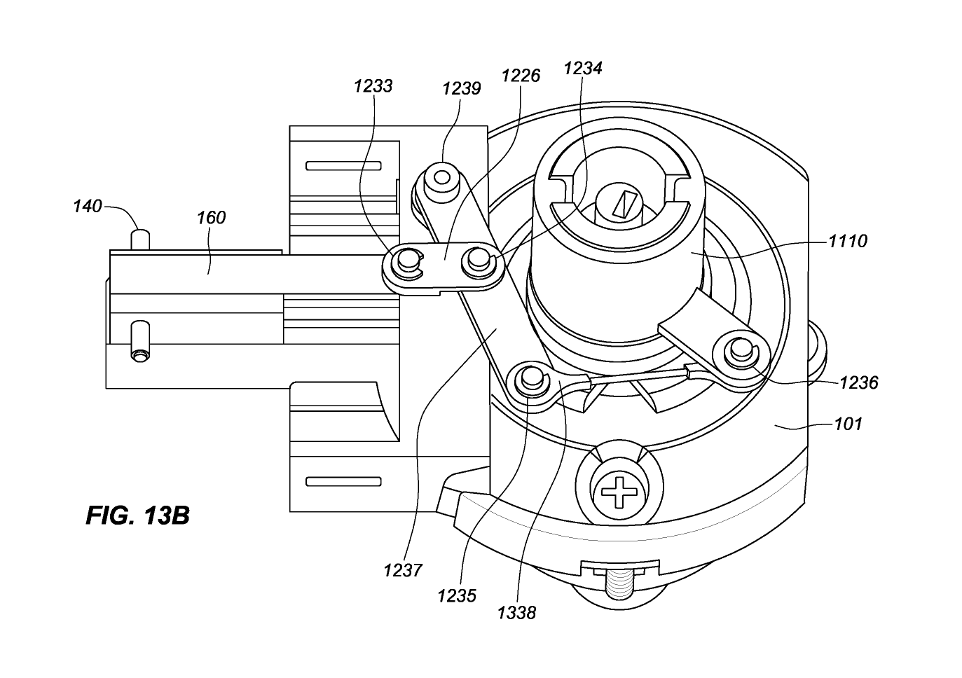

FIGS. 11A-13B illustrate alternative embodiments of the cylindrical latch exit device 100. In contrast to the linear movement of the embodiment of FIG. 1, FIGS. 11A-13B illustrate embodiments in which a pull linkage 160 is connected to another (“second”) linkage assembly (see FIGS. 11A, 12B, 13B) that rotates perpendicular to that of a standard door lever, as described below for the respective figures. For example, FIG. 11A illustrates an exemplary embodiment where the second linkage assembly can include a pull rod 320 and an arm 1112. FIG. 12B illustrates an embodiment where the second linkage assembly can include a primary pull linkage 1226, a secondary pull linkage 1237, and a tertiary pull linkage 1238. FIG. 13B illustrates an embodiment where the second linkage assembly can include a primary pull linkage 1226, a secondary pull linkage 1237, and a pull cable 1338. The second linkage assembly can translate the linear motion of the pull linkage 160 to a rotational motion by attachment to the latch assembly, such as to a handle stem, offset from the centerline of an axis of rotation. In this way, the rotating force can be provided to the handle stem via a coupling that mounts in place of a conventional lever, and provide rotational motion in a similar fashion as the conventional lever.

Embodiments can provide for transferring the perpendicular rotating force to a rotating motion in the same direction as that of a standard door lever via a linkage comprising of heim type connectors, or ball end joints, mated by a common threaded member.

FIGS. 11A and 11B illustrate an embodiment for providing a rotating motion from the push bar assembly. FIG. 11A illustrates a top plan view with partial cutaway showing a door 400, an exterior handle set 500, and push bar assembly 200 connected to the head piece 101. The actuator pin 140 on the pull linkage 160 is coupled with the slot 240 of the push bar assembly 200.

FIG. 11B illustrates a partial perspective view with partial cutaway showing the door 400, the exterior handle set 500, and the push bar assembly 200 connected to the head piece 101. The pull linkage 160 can be connected to one side of an inner axle linkage 1180 with a pin 1170. The other side of the inner axle linkage 1180 can be connected to an axle 1190. The axle 1190 can thereby transfer torque to the pull pivot 120.

In turn, as shown in FIG. 11A, the pull pivot 120 can be coupled to the pull rod 320 at one end. The ends of the pull rod 320 can be heim type connectors or ball end joints. The other end of the pull rod 320 can be connected to the arm 1112 extending radially from a rotator 1110. Movement of the arm 1112 can translate to rotational movement of the rotator 1110. In this way, the rotator 1110 takes the place of a conventional door handle, and the rest of the assembly performs as would a conventional cylindrical latch.

FIGS. 12A and 12B illustrate an embodiment using a plurality of linkages to provide the translation to rotate the rotator 1110 from the push bar assembly 200. FIG. 12A illustrates a partial perspective view with partial cutaway showing a door 400, exterior handle set 500, and push bar assembly 200 connected to the head piece 101. The actuator pin 140 on the pull linkage 160 of the head piece 101 is interfaced with the slot 240 of the push bar assembly 200.

FIG. 12B illustrates a partial perspective view with partial cutaway showing the head piece 101, the actuator pin 140, and the pull linkage 160 of the head piece 101. The primary pull linkage 1226 connects to the pull linkage 160 with a first pin 1233, and to the secondary pull linkage 1237 with a second pin 1234. The secondary pull linkage 1237 pivots on the head piece 101 at one end on pivot 1239, converting linear motion to rotational motion. The secondary pull linkage 1237 connects to the tertiary pull linkage 1238 with a third pin 1235 converting the rotation back to linear motion. The opposite end of the tertiary pull linkage 1238 connects to the rotator 1110 with a fourth pin 1236, providing the rotation as a conventional handle or knob normally would.

FIGS. 13A and 13B illustrate an embodiment using a plurality of linkages and a pull cable to provide the translation to rotate the rotator 1110 from the push bar assembly 200. FIG. 13A illustrates a partial perspective view with partial cutaway showing a door 400, an exterior handle set 500, and a push bar assembly 200 connected to the head piece 101. The actuator pin 140 on the pull linkage 160 of the head piece 101 is interfaced with the slot 240 of the push bar assembly 200.

FIG. 13B illustrates a partial perspective view with partial cutaway showing the head piece 101, the actuator pin 140, and the pull linkage 160 of the head piece 101. The primary pull linkage 1226 connects to the head piece pull linkage with the first pin 1233, and to the secondary pull linkage 1237 with the second pin 1234. The secondary pull linkage 1237 pivots on the head piece 101 at one end on pivot 1239, converting linear motion to rotational motion. The secondary pull linkage 1237 connects to the pull cable 1338 with the third pin 1235, converting the rotation back to linear motion. The opposite end of the pull cable 1338 connects to the rotator 1110 with the fourth pin 1236, providing the rotation as a conventional handle or knob normally would.

Although limited embodiments of cylindrical latching exit devices, its components, and related methods have been specifically described and illustrated herein, many modifications and variations will be apparent to those skilled in the art. Furthermore, it is understood and contemplated that features specifically discussed for one cylindrical latching exit device embodiment may be adopted for inclusion with another cylindrical latching exit device, provided the functions are compatible. Accordingly, it is to be understood that the cylindrical latching exit device, its components, and related methods constructed according to principles of the disclosed devices and methods may be embodied other than as specifically described herein. The disclosure is also defined in the following claim.

What is claimed is:

1. A push bar door exit device, comprising:
a latch actuation assembly configured to be installed in a door and including a linearly-movable latch retractor;
a door latch operatively coupled to the latch retractor so as to be moved from a latched position to an unlatched position by linear movement of the latch retractor; and
a push bar mechanism configured for being mounted on the door and including a linearly-movable push bar operatively coupled to the latch actuation assembly so as to translate a linear motion of the push bar into the linear movement of the latch retractor.

2. The push bar door exit device of claim 1, wherein the latch actuation assembly includes a rotatable handle operatively coupled to the latch retractor, wherein the latch retractor is linearly movable in response to rotation of the handle.

3. The push bar door exit device of claim 1, further comprising:
a pull pivot operatively contacting the latch retractor; and
a pull linkage operatively coupling the push bar to the pull pivot.

4. The push bar door exit device of claim 3, further comprising a head piece including a mounting tab, wherein the pull pivot is coupled rotatably to the mounting tab.

5. The push bar door exit device of claim 3, further comprising a head piece including a first mounting tab and a second mounting tab, wherein the first mounting tab and the second mounting tab are substantially parallel to one another and define a space between them, the pull pivot being coupled rotatably to the first mounting tab and the second mounting tab in the space.

6. The push bar door exit device of claim 4, wherein the pull pivot comprises a first end and a second end, the pull pivot being coupled rotatably to the mounting tab near the first end, the pull pivot contacting the latch retractor near the second end, and the pull linkage being coupled to the pull pivot at an intermediary position between the first end and the second end.

7. The push bar door exit device of claim 3, wherein the pull pivot presses against a surface of the latch retractor to move the latch retractor linearly.

8. The door latch actuation assembly of claim 7, wherein the pull pivot comprises a plurality of pull linkages configured to rotate a rotator; and wherein the linear motion of the push bar in a first direction causes the rotator to rotate, resulting in linear movement of the latch retractor in a second direction different from the first direction.

9. A method of installing a push bar door exit device in a door, the method comprising
mounting a push bar mechanism to a door, the push bar mechanism including a linearly-movable push bar;
installing a latch actuation assembly in the door, the door latch actuation assembly including a linearly-movable latch retractor;
coupling the latch retractor to a door latch, whereby the door latch is movable from a latched position to an unlatched position by linear movement of the latch retractor; and
operatively connecting the push bar mechanism to the latch actuation assembly so as to translate a linear motion of the push bar into the linear movement of the latch retractor so as to move the latch from the latched position to the unlatched position.

10. The method according to claim 9, wherein movement of the latch retractor is constrained by a cage to restrict movement of the latch retractor other than a linear direction.

11. The method according to claim 9, further comprising:
installing a pull pivot to contact the latch retractor; and
connecting a pull linkage to couple the push bar to the pull pivot.

12. The method according to claim 11, further comprising rotatably coupling the pull pivot to a mounting tab of a head piece.

13. The method according to claim 11, further comprising rotatably coupling the pull pivot to a first mounting tab and a second mounting tab of a head piece, wherein the first mounting tab and the second mounting tab are substantially parallel to one another and define a space between them.

14. The method according to claim 12, wherein the pull pivot comprises a first end and a second end, the pull pivot being coupled rotatably to the mounting tab near the first end, the pull pivot contacting the retractor near the second end, and the pull linkage being coupled to the pull pivot at an intermediary position between the first end and the second end.

15. The method according to claim 11, wherein the pull pivot presses against a surface of the latch retractor to move the latch retractor linearly.

16. The method according to claim 15, wherein the pull pivot comprises a plurality of pull linkages configured to rotate a rotator; the linear motion of the push bar in a first direction causes the rotator to rotate, resulting in linear movement of the latch retractor in a second direction different from the first direction.

17. A push-bar door exit device for actuating a door latch mechanism including a linearly-movable retractor operatively connected to a door latch, the push bar door exit device comprising:
a carrier having a mounting surface configured to be mounted on a surface of a door;
a push bar disposed in the carrier so as to be linearly movable in a first direction orthogonal to the mounting surface of the carrier; and
a latch actuator operably coupling the door latch mechanism to the push bar so as to move the retractor linearly to move the door latch linearly in a second direction parallel to the mounting surface of the carrier in response to the linear movement of the push bar in the first direction.

18. The push-bar door exit device of claim 17, further comprising a head piece including a mounting tab, wherein a pull pivot operatively contacts the retractor coupled to the door latch and is coupled rotatably to the mounting tab.

19. The push-bar door exit device of claim 18, further comprising:
a pull linkage to couple the latch actuator to the pull pivot;
wherein the pull pivot comprises a first end and a second end, the pull pivot being coupled rotatably to the mounting tab near the first end, the pull pivot contacting the latch retractor near the second end, and the pull linkage being coupled to the pull pivot at an intermediary position between the first end and the second end.

20. The push-bar door exit device of claim 19, wherein the door latch mechanism includes a rotatable handle operatively coupled to the latch retractor so that the latch retractor is linearly movable in response to rotation of the handle.
